(19) United States
(12) Patent Application Publication
(10) Pub. No.: US 2009/0144096 A1
(43) Pub. Date: Jun. 4, 2009

(54) VALUING ENVIRONMENTAL CREDITS

(75) Inventors: Jeff Andrilenas, Edgewater, NJ (US); Shawn Severn, Las Vegas, NV (US); Scott Lockert, Seattle, WA (US)

Correspondence Address: OSHA LIANG L.L.P., TWO HOUSTON CENTER, 909 FANNIN, SUITE 3500, HOUSTON, TX, 77010, US

(73) Assignee: S2 CORPORATION DBA BLUEFIELD HOLDINGS INC., Marietta, GA (US)

(21) Appl. No.: 12/328,219

(22) Filed: Dec. 4, 2008

Related U.S. Application Data
(60) Provisional application No. 60/992,256, filed on Dec. 4, 2007.
(60) Provisional application No. 61/022,998, filed on Jan. 23, 2008.

(51) Int. Cl. G06Q 40/00; G06Q 30/00; G06Q 50/00; G06Q 10/00

(52) U.S. Cl. 705/4; 705/400; 705/7; 705/37

(57) ABSTRACT

A method of creating environmental credits, the method including determining a damage caused by an environmental injury and determining a solution for the damage. Additionally, the method includes monetizing the solution into a credit that replace the damage, wherein the credit is valued in terms of the environmental injury, and creating the credit. Also, a method of valuing environmental credits, the method including determining a solution to an environmental damage and monetizing the solution into a credit. Additionally, the method includes valuing the credit based on the environmental benefits of the solution and outputting the valuation.

### CROSS-REFERENCE TO RELATED APPLICATIONS

This Application claims benefit pursuant to 35 U.S.C. § 119(e) of U.S. Provisional Application No. 60/992,256, filed Dec. 4, 2007 and U.S. Provisional Application No. 61/022,998, filed Jan. 23, 2008. Both applications are hereby incorporated by reference in their entirety.

### BACKGROUND

1. Field of the Disclosure

Embodiments disclosed herein relate generally to methods of creating environmental credits. More specifically, embodiments disclosed herein relate to methods of creating environmental credits used in offsetting environmental liability. More specifically still, embodiments disclosed herein relate to methods of eliminating environmental liability through implementation of credit generating operations.

2. Background Art

Environmental liability arising from damage to ecological systems typically includes damage to the land, water and air. However, environmental liability may also arise from other natural resource damages, such as injury to fish, wildlife, biota, groundwater, drinking water, etc. Damage to the environment, and thus environmental liability, may occur as a result of general pollution or specific events, such as oil spills, mining operations, construction, and industrial processes.

Traditionally, compensation for damage to the environment was pursued under resource damage claims under authority of the Comprehensive Environmental Response, Compensation and Liability Act of 1980 (“CERCLA”), the Oil Pollution Act of 1990 (“OPA”), and various state statutes. Claims brought under the traditional methods primarily sought compensation for injury to surface water, sediments, fish, and wildlife resources, and were normally only brought if the environmental impact spanned a large area.

Until recently, claims brought under the authority of CERCLA, and other traditional methods, addressed damage liability from a site cleanup/remediation perspective. However, recently, environmental liability has transitioned to include not only site cleanup, but also to include Natural Resource Damages (“NRD”) and the costs of restoration. The objective of NRD is to make the public whole through restoration. Generally, NRD includes both primary and compensatory restoration. Primary restoration returns injured natural resources and services to a base level, and may include, for example, restoration, replacement, rehabilitation, or acquisition of resources equivalent to the injured natural resources or services. Compensatory restoration includes the losses from the date of the incident until natural resources are restored to the base level. Said another way, the economics of NRD include the costs of assessing the damages, the value of lost services, and costs to restore the injured natural resources.

One emerging trend in NRD claims is to seek compensation for actual and potential damages due to groundwater contamination. Generally, groundwater NRD claims provide that a groundwater source has been damaged by a release of a hazardous substance on to the land and these hazardous substances have migrated to the groundwater. As such, the responsible party must compensate a trustee of the groundwater for the damages. Even if the responsible party is actively remediating the land and groundwater, thereby returning the resource to base level, the responsible party must still compensate the trustee for damage to and loss of the groundwater while the contamination existed. Additionally, because remediation may take many years, the responsible party may remain liable to the trustee for damages to the resource until remediation is complete.

Due to the large scale damages that may accrue, settlements made between responsible parties and trustees often range between thousands and millions of dollars. Recently, during settlement, an industrial company agreed to set aside more than 1800 acres of land, pay over 1.8 million dollars for tree planting, and directly pay the trustee 500,000 dollars to compensate the trustee for groundwater damage at several sites. Typical methods for the quantification of damages include simple computations. For example, in a basic groundwater claim, a typical method of assigning a value to the damaged groundwater is to determine the extent of the damage, in terms of area, and multiply the area by an annual recharge rate, such that a volume of water for each year that the damage exists is determined. The volume of damaged groundwater is then multiplied by the duration of the damage to determine the total volume of affected water. The total volume of affected water is then multiplied by the rates charged for potable water to determine a total dollar value for the claim.

While historically the methods for assigning a value to a claim focused on monetary compensation, service-to-service restoration is another option. For example, in service-to-service restoration, rather than monetary remuneration, specific resources may be replaced. In the example provided above, the 1800 acres of set aside land may offset groundwater lost due to damages. Thus, to replace at least a portion of the lost groundwater, a responsible party may, for example, set aside a portion of land containing an aquifer to at least partially offset the loss by allowing passive recharge of the groundwater.

While service-to-service restoration has the added benefit of replacement of the lost resource while offsetting the monetary damages, such restoration techniques have other limitations. Because a service-to-service project often requires compensatory sites, in many jurisdictions within the same region as the damaged environment, land values have increased exponentially. As such, the cost of providing for the passive recharge of a resource by setting aside land has also increased exponentially. In some regions, land for passive recharge is now so scarce, that settling land aside as a contribution toward restoration is virtually unfeasible. However, because buying out of the claim is not an option, responsible parties are locked into an inefficient and expensive system that is practically unsustainable.

Accordingly, there exists a need for methods of valuing and creating environmental credits to offset environmental liability.

### SUMMARY OF THE DISCLOSURE

In one aspect, embodiments disclosed herein relate to a method of creating environmental credits, the method including determining a damage caused by an environmental injury and determining a solution for the damage. Additionally, the method includes monetizing the solution into a credit that replace the damage, wherein the credit is valued in terms of the environmental injury, and creating the credit.

In another aspect, embodiments disclosed herein relate to a method of valuing environmental credits, the method including determining a solution to an environmental damage and monetizing the solution into a credit. Additionally, the method includes valuing the credit based on the environmental benefits of the solution and outputting the valuation.

In another aspect, embodiments disclosed herein relate to a method of satisfying environmental liability, the method including determining an environmental liability, wherein the environmental liability is based on an environment, and selecting a recharge operation, wherein the recharge operation produces a product. Additionally, the method includes quantifying the product of the recharge operation, wherein the quantifying includes translating the product of the recharge operation into a monetized solution, and implementing the recharge operation.

Other aspects and advantages of the invention will be apparent from the following description and the appended claims.

### BRIEF DESCRIPTION OF DRAWINGS

FIG. 1 is a flowchart of a method of creating environmental credits according to embodiments of the present disclosure.

FIG. 2 is a flowchart of a method of valuing environmental credits according to embodiments of the present disclosure.

FIG. 3 is a flowchart of a method of addressing environmental liability according to embodiments of the present disclosure.

FIG. 4 is a flowchart of a method of prospect development according to embodiments of the present disclosure.

FIG. 5 is a flowchart of a metric of liability according to embodiments of the present disclosure.

FIG. 6 is a flowchart of a financial model according to embodiments of the present disclosure.

FIG. 7 is a flowchart of a financial model according to embodiments of the present disclosure.

FIG. 8 is a graph of credit generation over time according to embodiments of the present disclosure.

FIG. 9 is a graph of credit generation over time according to embodiments of the present disclosure.

FIG. 10 is a graph of credit stacking according to embodiments of the present disclosure.

FIG. 11 is a computer generated visual representation of modeled calculations according to embodiments of the present disclosure.

FIG. 12 is a computer generated visual representation of modeled quantitative factors according to embodiments of the present disclosure.

FIG. 13 is a computer generated visual representation of modeled qualitative factors according to embodiments of the present disclosure.

FIG. 14 shows a computer system in accordance with one or more embodiments of the present disclosure.

### DETAILED DESCRIPTION

In one aspect, embodiments disclosed herein relate to methods of creating environmental credits. More specifically, embodiments disclosed herein relate to methods of creating environmental credits used in offsetting environmental liability. More specifically still, embodiments disclosed herein relate to methods of eliminating environmental liability through implementation of credit generating operations.

As discussed above, environmental liability is created when a party causes damage to an ecological system. Generally, the injury is a type of damage to the ecosystem, and may include, for example, loss of groundwater, habitation, wildlife, resources, etc. The injury is typically the result of an event that resulted in an environmental impact. Exemplary events that result in environmental impacts may include manufacturing, oil spills, construction, and general industrial activity. Those of ordinary skill in the art will appreciate that varied types of events may occur, thereby causing varied environmental impacts germane to the specific event that occurred. Certain events may be one time events, such as an oil spill, while other events may be substantially continuous for long periods of time, such as industrial activity and manufacturing. Additionally, the range of impact is not area dependent. For example, an event, such as an oil spill, may result in tens of thousands of barrels of oil being spilled in a large area. The oil may then continue to spread due to settlement in the water and drift due to currents. The environmental impact may thus include all areas affected by the event (i.e., the oil spill), not merely the initial site.

Similarly, in an industrial manufacturing event, a manufacturer may damage groundwater due to years of dumping and chemical seepage during ordinary operations. Contamination of the groundwater may thus spread to include damage to an entire aquifer, ecosystem, ecotone, or other definable area. In such a circumstance, the event and resulting environmental impact may include the entire affected area, not simply the land onto which the chemicals were deposited.

When an event occurs that results in an environmental impact, a plume is created. A plume includes an area of air, water, or land that contains pollutants released from a central source. The plume may further the spread of the pollutants into the environment due the wind, currents, gravity, or other natural action. The plume thus represents a definable area containing pollutants do to an event, as described above. Those of ordinary skill in the art will appreciate that while a plume is generally a definable area, in certain aspects disclosed herein, a plume may also represent an area believed to be impacted by an event. For example, in certain aspects, an assessment may be provided by a responsible party or a trustee when determining the area defined by the plume. As such, the plume may include both actual and perceived areas of injury.

After an event occurs, a trustee of land injured by an environmental impact may bring a claim against the responsible party in accordance with, for example, CERCLA, OPA, or specific state statutes. The responsible party, upon a finding of liability, may then be held accountable for cleaning up the plume, as well as compensating the trustee for the resources lost during the time that the plume existed. Formulas, such as those discussed above, may be useful in determining the value of the land and the resources. After the value of the land and resources is calculated, the responsible party must compensate the trustee in terms of both monies and resources for the damages incurred during the existence of the plume. While the monetary portion is generally a lump sum amount owed to the trustee, the resource replacements provides unique challenges to the responsible party.

Generally, in one embodiment, an event occurs, thereby resulting in an environmental impact. Either immediately or over time, the environmental impact may result in an injury to the environment. The injury may include damage to the land itself or damage to another natural resource encompassed by the land. Additionally, the injury may stem from both direct and indirect environmental impacts. For example, a chemical spill may directly injure a water source and wildlife that come into contact with the chemical. However, the chemical spill may also seep into aquifers, lakes, rivers, or the ocean, thereby indirectly injuring foreign water sources and wildlife that rely on the water sources. When defining the range of the injury, the entire affected area may be considered.

After the event occurs, the injury caused by the event is determined. The determination of the injury may include an environmental site assessment to identify the extent of contaminants at a specific site. In certain embodiments, the determination of the injury may alternatively include receipt of a prior site assessment indicating the extent of the injury. The determination may include factors such as an area of land affected and a volume of resources affected. In certain embodiments, the determination may also include the residual effects of loss of the resource or land on humans, loss of efficiency as a result of the loss of the use, and other social and cultural impacts.

When the extent of the injury is determined, the injury may then be quantified. Quantification of the injury may include determination of monetary damages and resource damages. Monetary damages include the lost monetary value of the land, while resource damages include the damage to the resources affected by the plume. The calculation of resource damages is generally more difficult than the calculation of monetary damages, at least in part, because resource damages may include damages that change over time.

The determination of the injury may thereinafter lead to an environmental liability for the party responsible for the plume. Creation of the environmental liability may thus necessitate remediation and restoration of the area affected by the plume, as well as compensation for injury to the area during the presence of the plume. The compensation may require, among other things, replacement of lost resources caused by the plume.

The below described embodiments of the present disclosure provide methods for valuing and replacing the resources owed by the responsible party to the trustee. Additionally, the present disclosure provides methods for creating credits usable to settle the environmental liability incurred by the responsible party. Those of ordinary skill in the art will appreciate that while the below embodiments will be discussed with specific reference to groundwater contamination, the general methodology disclosed herein may be applicable in any environmental liability context. For example, in other embodiments, the methods of creating environmental credits and valuing resources may be used in environmental liability actions caused by oil spills, chemical spills, industrial waste, deforestation, etc.

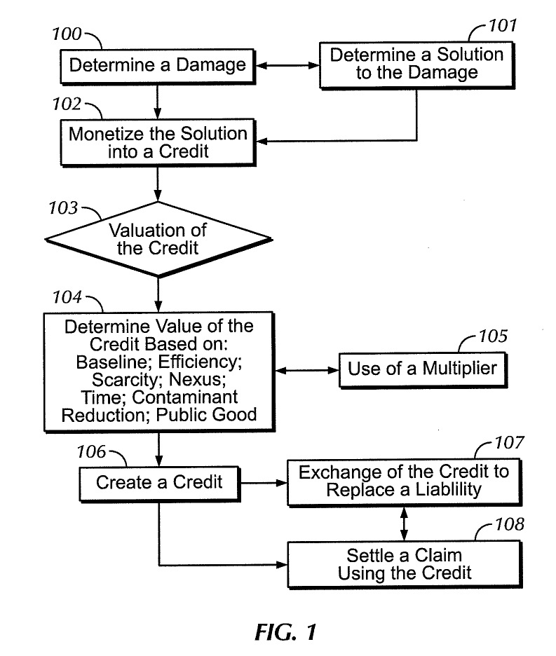

Referring to FIG. 1, a flowchart showing a method of creating environmental credits according to embodiments of the present disclosure is shown. In this embodiment, a damage (i.e., a loss of use) caused by an environmental injury is determined 100. The damage may include both monetary and resource damages; however, for clarity, only the resource damages will be discussed with regard to FIG. 1. Additionally, the resource damage may include both direct and indirect damages, such as injury to wildlife, water sources, air, etc.

After the damage has been determined 100, a solution to the damage is determined 101. The solution to the damage may include generation of a product capable of replacing the resource damaged by the environmental injury. For example, if the damage includes contaminated groundwater, the solution could include replacement water produced via active processes. In one embodiment, the solution may include rainwater collected off of rooftops and parking lots on developed properties. The water may also be treated and pumped into an aquifer via injection for storage. The solution thereby becomes a replacement product capable of replacing the damaged resource, but not requiring the purchase of land, as would be required according to current methods of replacing damaged resources.

Additionally, the solution may occur either within the same watershed as the damage, if local regulations require, or may occur in a different location and be transported to the watershed. Those of ordinary skill in the art will appreciate that in certain embodiments, certain aspects of the solution may occur at the watershed, while other aspects of the solution occur away from the watershed. The determination of where the solution is generated may be decided based on factors such as the cost of transportation, the availability of necessary resources, infrastructure of the region, and the requirements of the statute under which the claim is based.

After the solution is determined 101, the solution is monetized 102 into a credit that replaces the damage. The monetization 102 of the solution allows for the credit to represent a certain quantity of damage. For example, with reference to the groundwater example above, the collection of water from rooftops may be collected in sufficient volume to substitute for a damage (e.g., when the damage includes a calculated volume of groundwater). As such, the process of actively collecting, treating, and storing water provides for a volume of water capable of offsetting a determined volume of damaged groundwater.

Those of ordinary skill in the art will appreciate that monetization 102 generally refers to the conversion of the solution or product into a credit. As such, the solution or product is tradable at a price as determined by the value of the representative resource. For example, the active collection of water may be monetized 102 into an environmental credit that replaces the damaged groundwater. As such, the credit becomes valued in terms of the environmental injury, in this case, the damaged groundwater.

In another embodiment, monetization 102 may refer to the conversion of the solution or product into a credit representative of an equivalent solution. For example, the active collection of water may be monetized 102 into an environmental credit that replaces the damaged groundwater, but is valued as compared to a specified volume of water that would otherwise be collected from a passive recharge area. In either embodiment, the valuation of the credit allows the credit to be sold to a responsible party without requiring the responsible party to purchase the land (i.e., the passive recharge area).

The monetization 102 of the credit may also include valuation 103 of the credit. Valuation 103 of the credit includes determining 104 a value of the credit based on, for example, a baseline calculation, a recharge efficiency, a scarcity, a nexus factor, a time factor, a public good factor, or combinations of the above. Valuation in terms of a recharge efficiency may include valuing the credit as compared to an alternative to the solution. For example, a credit monetized from an active water collection solution may be valued based on an acre or volumetric comparison of the collected water to water credits available from a passive recharge area. In such an embodiment, the passive recharge area provides a baseline for valuing the credit monetized from the active solution.

Valuation 103 in terms of a recharge efficiency allows for the comparison of the efficiency of the solution when compared to the efficiency of an alternative to the solution. For example, the credit for actively collected groundwater may be valued in terms of its efficiency as compared to the efficiency of the passive recharge area. In this embodiment, because active recharge may provide for a greater volume of water collected per acre than the passive recharge area, the recharge efficiency may serve as a multiplier to the value of the credit. The recharge efficiency may also be used to determine whether the solution is more efficient than an alternative to the solution. If the alternative to the solution is more efficient than the solution, a credit generator/analyzer may determine that the solution should not be pursued. However, those of ordinary skill in the art will appreciate that depending on the specific factors used in the valuation, a solution that is less efficient than an alternative to the solution may still be selected as a viable option. Such an option may occur because the net value of the credit may still be greater than the value provided by the alternative to the solution.

In another embodiment, valuation 103 may include consideration of a scarcity factor. Scarcity may refer to the scarcity of both a means to produce a solution and/or the scarcity of the alternative to the solution. For example, scarcity in terms of the means to produce the solution may be a negative consideration when land or appropriate infrastructure does not exist to allow for the collection of water. However, when the means to collect water is abundant, scarcity may be a net positive consideration. Similarly, scarcity may be a consideration with respect to the alternative to the solution. For example, in a region where passive recharge land is not available, scarcity may be a positive consideration for the solution, and thus a positive consideration for the valuation. However, in a region where passive recharge land is abundantly available, scarcity may be a negative consideration for the solution. Those of ordinary skill in the art will appreciate that scarcity may also be considered in terms of both the solution and the alternative to the solution together, in accordance with the methods disclosed above.

In other embodiments, a nexus factor may be considered during valuation 103. Nexus may include an evaluation of the connection of the damage to the solution. For example, the damage refers to the shortages of groundwater, and the damage is determined based on both the volume of groundwater and the location of the groundwater. Thus, an evaluation of nexus may provide for an incentive to produce a solution, such as collected water, in proximity to the damage. In another embodiment, nexus may be used to provide for increased value when the solution is procured from a location that has greater efficiency, such as from an active collection site collecting an optimal volume of water. Those of ordinary skill in the art will appreciate that nexus may vary according to the specific credit being valued, but generally induces a net positive consideration for more efficiently developed solutions.

Those of ordinary skill in the art will appreciate that nexus may also include connectivity. Connectivity describes the additive value of habitats that are situated in proximity to one another. For example, habitat that is located in close proximity or connected to other viable habitat may be more functional in promoting and/or providing a solution to the environmental damage. Thus, value of the solution may be increased as a result of the connectivity because a more closely connected solution may provide subsidiary benefit to the ecosystem. Similarly, a solution distinct from the environmental damage either due to proximity of the location or other intervening factors may have low connectivity. Accordingly, low connectivity solutions may have lower value. Those of ordinary skill in the art will appreciate that connectivity may be determined independently or in connection with a nexus determination. As such, in certain embodiments, proximity, efficiency, locality, and other factors known to those of skill in the art may be determined in a nexus and/or connectivity determination.

Valuation 103 may be determined based on a time factor. The time factor may include consideration of the time it takes for a solution to reach a damage location, or may alternatively refer to the time it takes for the solution to reach a receiving area. For example, a time factor may be used in the valuation of a groundwater credit to take into account the time it takes for collected water to be injected, and subsequently reach the damaged aquifer. In other embodiments, time may be used as a consideration for the time it takes for collected water to enter the potable water supply.

In certain embodiments, a general public good factor may be considered during valuation 103. The public good benefit factor may be used as an incentive for private sector development, and may also be used as an incentive to encourage the development of solutions on public lands, such as schools, parks, and public right-of-ways. As such, both private and public entities may use existing infrastructure in the production of a solution. For example, the public good factor may be used during valuation to provide an incentive for a school to collect water. In another embodiment, a private business, such as a parking garage may be encouraged to collect water.

In still other embodiments, a contaminant reduction factor may be considered during valuation 103. Contaminant reduction includes consideration for the removal of pollutants necessarily remediated during the production of the solution. For example, for water collected in urban areas, prior to injection into an aquifer, the water is treated, necessarily removing oils, greases, and contaminants entrained therein that would otherwise enter the water supply. Such a contaminant removal may also provide for a compounded, or stacked credit. In such an embodiment, removal of the petroleum from road oils provides a direct credit attributable to the OPA for the natural resource damage restoration portion that responsible parties must settle on a pound-for-pound basis. Thus, the removal of the oil may provide for a secondary credit, thereby increasing the value of the first credit. Other examples of stackable credits available in certain operations may include removal of contaminants, such as nitrogen and organics chemicals.

In still other embodiments, other factors may be used during the valuation 203 of the credit. Additional factors may include specific environmental benefit factors and other factors as may be obvious to those of ordinary skill in the art. In certain embodiments, all of the above listed factors may be considered in a single valuation to produce a definable value for a credit. In such an embodiment, each factor may be assigned a weighted value according to the importance of the value to a specific type of credit. The determination of the weighting may vary, but the use of the factors may therein provide a scientifically determined value for the credit.

In one embodiment, the value of the credit may be determined through use of an efficiency multiplier 105. The efficiency multiplier may include any of the factors discussed above, such as, a scarcity factor, a nexus factor, a time factor, a baseline factor, a public good factor, a contaminant removal factor, or an environmental benefit. After defining the efficiency multiplier, the multiplier may be used to determine a value for the credit. Examples of use of the multiplier may include assigning one or more of the above listed factors qualitative and quantitative modifiers, such that a value in terms of the considerations embodied by the factors is determined. Thus, in one embodiment, an efficiency multiplier may include assigning a scarcity factor a modifier making it twice as important as the contaminant removal factor. Such weighting may thereby allow for valuation of a credit in terms of both scarcity and contaminant removal, such that scarcity defines the priority consideration. In other embodiments, a plurality of both factors and associated modifiers may be used when assigning/determining a value of a credit.

After the credit is created 106, monetized 102, and/or valued 103, the credit may be exchanged 107 in replacement for a liability. In such an aspect, a responsible party may transfer rights of the credit to a trustee holding a claim against them, thereby providing for the settlement 108 of a claim, or a portion of the claim.

Those of ordinary skill in the art will appreciate that other types of credits may be created in accordance with the methods disclosed herein. For example, in one embodiment, the credit may be an ecological credit. In such an embodiment, the event may be a contaminated river, and the injury may include destruction of the habitat of a specific species. Thus, the liability is derived from the impact on the species. An ecological credit could be created and valued in terms of the habitat, such that the solution would be the creation of a habitat for the type of species affected by the contamination of the river. Such ecological credits may promote the creation of habitats for species that may otherwise be lost.

In other embodiments, the credit may be a cultural credit. In such an embodiment, a group of individuals may have had rights to a species, but an event impacted the species. Thus, a cultural damage was created due to the individuals' inability to harvest the species. A cultural credit could thus be created to compensate the individuals for loss of the species.

Cultural credits also include credits that may be transacted to offset damage to a natural resource that occurred as a result of the release of a hazardous substance into the environment. Such a cultural credit may thus be used to compensate an individual or group of peoples for the loss of use of the natural resource. Projects that may form solutions to the lost natural resource include providing access to usual and accustomed hunting grounds, fishing and gathering grounds, and restoration of cultural activities connected to the damaged resource. In still other embodiments, lifestyle changes to an affected group of peoples, including economic restoration, may be accounted for with the creating and subsequent transacting of cultural credits. In still other embodiments, solutions that result in cultural credits may include developments allowing for the group of people affected by the lost natural resource to provide replacement resources and/or promote knowledge about the resources. Thus, the cultural credit may include a valuation of both a present and a future benefit of the solution.

Those of ordinary skill in the art will appreciate that in certain embodiments, cultural credits may be created through programs that preserve or enhance cultural practices. For example, in one embodiment, a group of Native Americans may have lost the ability to use a natural resource (e.g., the ability to hunt a certain species) as a result of an environmental damage. The loss of the resource further resulted in certain customs that the group of people developed over hundred of years (e.g., customary hunting methods and practices) to be impacted. To offset the loss of the customs of the Native Americans, a cultural credit may be created by providing a solution to support and/or maintain traditional Native American cultural practices. In one aspect, the solution may include creation of a cultural center so that Native Americans, as well as other members of the population, may continue to experience and learn about the customary practices. As such, the solution to the loss of use of the resource may provide a tangible focus to an otherwise intangible impact caused by the environmental damage. Those of ordinary skill in the art will appreciate that in other embodiments, the solution may include activities such as species repopulation, cultural education, and other methods of preventing the loss of cultural practices.

In still other embodiments, a credit may include a social credit. Social credits may include a credit created and valued based on, for example, the distribution of environmental goods and services across income and demographic groups. Those of ordinary skill in the art will appreciate that one form of a social credit may include value of a credit in terms of environmental justice. The social credit may thus include valuation of a solution in terms of a benefit to a group of peoples. Because solutions to environmental damages often have disparate impact on different groups of people, solutions that lower the impact on a group of people, or otherwise provide a solution having a lower net impact on the peoples may be valued. A credit may then be created based on the value of the benefit of the solution as opposed to the damage to the group of people that may otherwise occur.

In other embodiments, a social credit valued in terms of environmental justice may have innate value based on an expected or realized benefit of the solution on a group of peoples' lives. In an exemplary embodiment, a solution may be valued in terms of a comparison between a baseline demographic condition and an expected demographic condition after implementation of the solution. The comparative analysis may initially include the creation of a baseline through compiling socioeconomic variables such as income, ethnicity, and employment/unemployment data. The baseline may then be compared to an expected change in the demographic condition, and value to the change may be monetized in terms of a social credit.

Those of ordinary skill in the art will appreciate that benefits that may be monetized in creation of the credit include direct investment expenditures, innate savings, and a reduction in expected damages. Examples of direct investment expenditures include actual or estimated tangible monetary contributions to a specified region. Innate savings include a cost savings calculation that may result from the implementation of the solution. The cost savings may thereby represent a measurable economic benefit for a specific community, government, or region. A reduction in expected damages includes valuing the credit in terms of a reduction in the likelihood of an anticipated future damage. For example, by changing a flooding potential of a locality as a result of implementing an active water collection solution, the solution may include a social value (i.e., the value of the locality not flooding). Those of ordinary skill in the art will appreciate that additional benefits may considered in the monetization of a social credit. Other benefits may include benefits associated with changes in employment patterns, sustainable infrastructure, land value, tax savings, and other quantifiable changes generated either directly or indirectly by the solution.

Those of ordinary skill in the art will appreciate that any type of credit used in addressing environmental liability may benefit from aspects of the present disclosure. Parties using credits created according to embodiments disclosed herein may further benefit from the methods of valuation, transacting, and settlement opportunities.

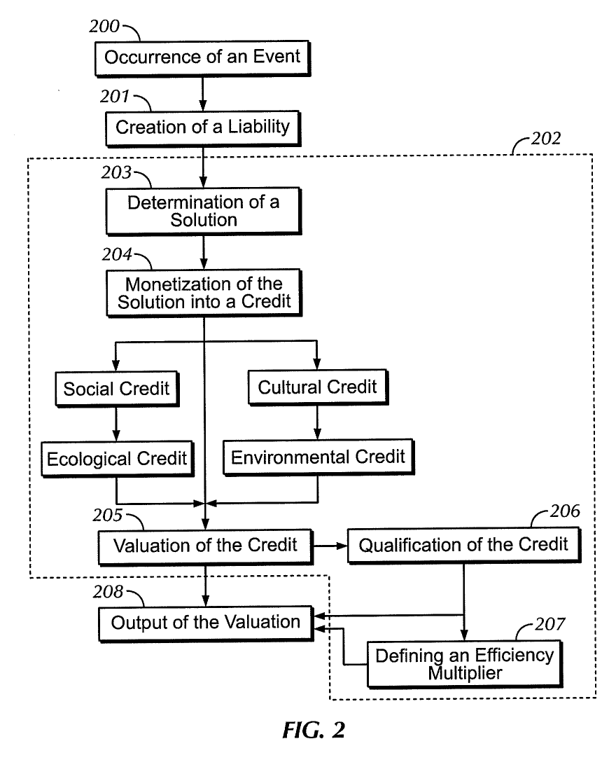

Referring to FIG. 2, a flowchart of a method of valuing environmental credits according to embodiments of the present disclosure is shown. Those of ordinary skill in the art will appreciate that embodiments of the methods disclosed in FIG. 2 may be assisted via use of a computer. As such, the values, factors, and multipliers discussed below may be input into a computer system, such that a value of a credit may be determined. In this embodiment, an event occurs 200 that causes an environmental injury. Compensation for the environmental injury is then claimed against the responsible party, and a liability is created 201. After the liability is created 201, the method of credit valuation may be used to determine the value of a solution to a damaged resource as compared to either the value of the resource or the cost associated with an alternative to the solution (e.g., a passive recharge area).

Initially, the valuation 202 of a credit begins with the determination 203 of a solution to the environmental damage. The determination may include analyzing the type of damage, and either implementing a program to produce an equivalent or replacement product, or otherwise using an existing solution. For example, in one embodiment, a solution may be selected from an existing set of known solutions, such as an existing recharge or groundwater collection operation. However, in other embodiments, a solution may not exist that meets the requirements of the liability. In such an embodiment, the valuation may be based on a newly designed solution, such as the establishment of a new recharge operation. As such, the determination 203 of the solution may also include identification of an appropriate solution for the environmental damage.

After a solution has been determined 203, the solution is monetized 204 into a credit. Monetization 204 may include creating a tradable financial product based on a solution, as discussed above. Exemplary types of credits include environmental credits, ecological credits, cultural credits, social credits, and other types of credits as would be known to those of ordinary skill in the art. In certain embodiments, a single credit may include aspects of multiple credits, so that a solution may effectively provide a replacement product for multiple damages. In such an embodiment, a primarily environmental credit may also include aspects of an ecological credit, and similarly, a primarily cultural credit may include aspects of an ecological credit.

After monetization 204 of the solution into a credit, the credit may be valued 205 based on the environmental benefits of the solution. Examples of environmental benefits may include, for example, the type of damage being replaced, the value of the resource, and the efficiency of the process used to create the solution. In certain embodiments, valuation 205 may include quantifying 206 the credit based on the environmental benefits. Examples of quantifying 206 credits may include measuring the value of the credit relative to an alternative to the solution, or otherwise measuring the value of the credit relative to the damage value of the lost resource. More specifically, quantifying 206 may include defining 207 an efficiency multiplier and determining the value of the credit based on the efficiency factor. Examples of efficiency factors include baseline calculations, recharge efficiencies, scarcities, nexus, time calculations, public good, contaminant removal, and environmental benefits, as discussed in detail above. Those of ordinary skill in the art will appreciate that in certain embodiments, the efficiency multiplier may use several or even all of the above listed factors when quantifying the credit. Furthermore, depending on the types of resources being replaced, the credit may gain value at least in part due to the stacking of the credits. Credit stacking would thus allow for the valuation 205 of the credit to include intrinsic value associated with the production of a solution.

After the credit is valued 205, the valuation may be output 208 by a computer. The output 208 may include displaying the valuation numerically, visually, graphically, textually, or otherwise on a monitor. Alternatively, the output may include printing the valuation, storing the valuation in a database, transferring the valuation through use of a network, or otherwise transmitting the data. Those of ordinary skill in the art will appreciate that the methods of valuing environmental credits discussed above may include additional steps not discussed in detail, such as implementation of a recharge operation capable of producing the solution. Additionally, after valuation of the credit, the credit may be used as a financial product that is purchasable and tradable in the elimination of environmental liability.

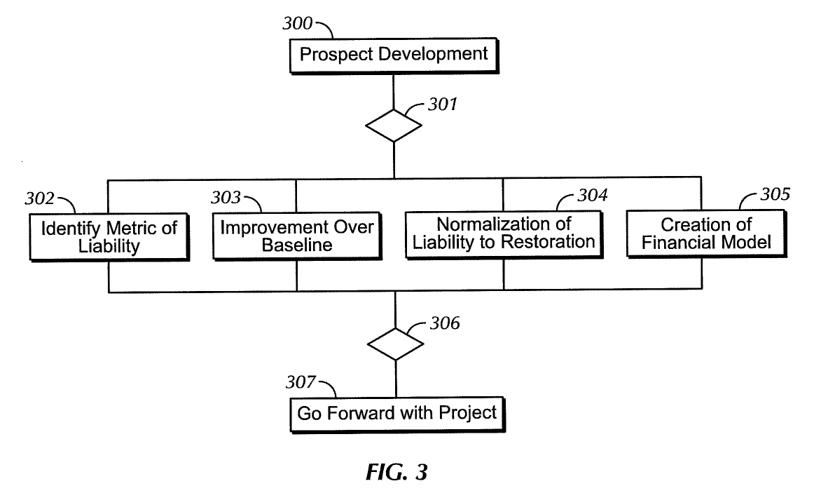

Referring to FIG. 3, a flowchart of a method of addressing environmental liability according to embodiments of the present disclosure is shown. Initially, a prospect development 300 is identified. The prospect development identification 300 includes defining an environmental liability and analyzing an environmental injury caused by an event. The identification of the prospect development 300 may further provide information about the types of resources that have been affected, the time the resources have been affected, and other site specific information regarding the land and/or resource damage. If the prospect development 300 includes a damage for which a credit may be applicable, a responsible party, or organization that creates environmental credits may choose to go forward (indicated as a Yes option in decision box 301) with research into solutions and financials models for the credit. Upon deciding to proceed with evaluating the prospect 300, the credit organization may evaluate the resource damage and corresponding credit in terms of identifying a metric of liability 302, improvement over the baseline 303, normalization of liability to restoration 304, and the creation of a financial model 305.

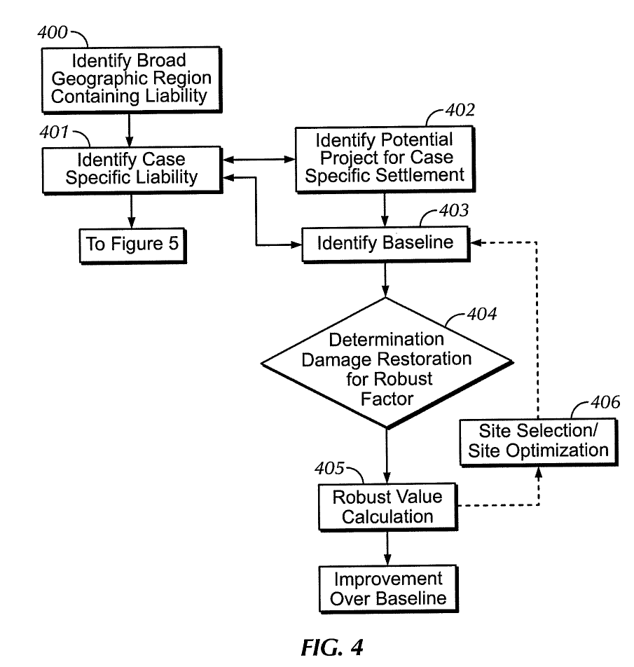

Referring now to FIG. 4, a flowchart of a prospect development according to an embodiment of the present disclosure is shown. Those of ordinary skill in the art will appreciate that the methodology described with respect to FIG. 4 may be manually performed by humans, or may alternatively be performed through the use of a computer. The term “analyzer,” as used herein, is germane to both human and computer generated analysis. As such, those of ordinary skill in the art will appreciate that any outcomes, determinations, calculations, or decisions may be output and displayed for a user to interpret and use.

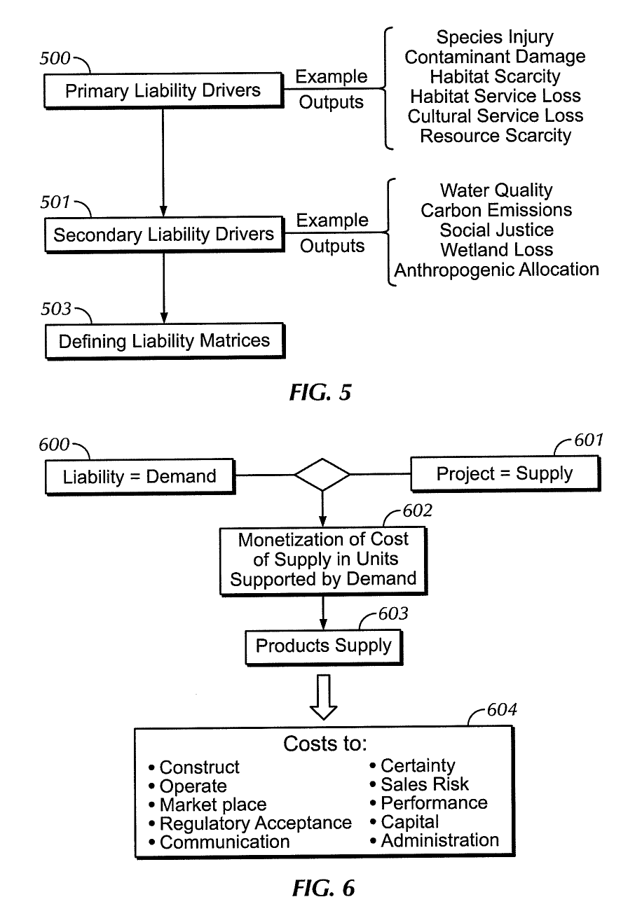

In this embodiment, an analyzer first identifies a broad geographic region containing a liability 400. After identifying the region containing the liability 400, the analyzer may then identify a case specific liability 401, including for example, a specific damage to a resource. Both the identification of the region 400 and the identification of the specific liability 401 may thus be used in determining whether the project may be used for credit generation in the particular region for the specific liability. If either the region does not accept the credits or the specific liability is not replaceable, an analyzer may choose to terminate the investigation. However, if the region accepts the credit and the resource is replaceable, then the analyzer may then proceed to identify a potential project for a case specific settlement 402 or proceed to considering the metric of liability (illustrated in detail in FIG. 5).

If the analyzer decides to identify a case specific settlement 402, the analyzer then identifies a baseline 403 representative of, for example, a passive recharge area. After identification of the baseline 403, the analyzer determines damage restoration to produce a robust factor 404. Determination of the damage restoration for a robust factor 404 includes the determination of how much of a replacement resource must be produced to offset the liability. Those of ordinary skill in the art will appreciate that robustness may specifically refer to the viability of a solution in reaching a fungible outcome. Thus, in one embodiment, a robust factor may be defined as the likelihood that a specific solution results in a positive fungible outcome.

After the determination of the damage restoration for a robust factor 404, the analyzer calculates the robust value 405. The robust is defined as a value of the produced solution that at least meets the stated demand of the liability. Those of ordinary skill in the art will appreciate that if the value of the produced solution does not meet the stated demand, then the project does not have the requisite value to proceed. However, in situations where the robust factor is greater than the stated demand, the project may go forward, because the value of the produced solution at least covers the requirements of the demand.

After the calculation of the robust value 405, the analyzer proceeds with site selection and site optimization 406. The selection and optimization may thus iteratively determine the specifics of the site that will result in the highest robust value calculation 405. As such, the analyzer may repeat the steps of identifying specifics of the settlement 402, re-identifying baselines 403, determining damage restoration 404, and re-calculating the robust value 405. In addition to the above, the analyzer may identify multiple solutions and compare the solutions such that an optimal site or a site that is optimized is produced. After optimization of the specifics of the project, the analyzer may either output the results, such that an optimized plan is produced, or the optimized plan (including the specifics of the plan) may be further analyzed comparatively with the case specific liability 407.

An optimized plan may then be analyzed with regard to an improvement over the baseline (303 of FIG. 3). The improvement over the baseline may include characterizing the sites, defining and measuring improvements, and tracking a development of the improvement. As such, the analyzer may determine whether the project is an improvement over the baseline, and if it is an improvement, may quantify the improvement in terms of resources produced and/or the efficiency factors discussed above.

During the identification of the site specific liability 401, the analyzer may determine the liability according to the metric of liability (302 of FIG. 3). Referring to FIG. 5, a flowchart for identifying a metric of liability according to an embodiment of the present disclosure is shown. In this embodiment, the metric of liability includes analysis of primary liability drivers 500 and secondary liability drivers 501. Primary liability drivers 500 may include species injury, contaminant damage, habitat scarcity, habitat service loss, cultural service loss, resource scarcity, and any of the liabilities of importance. Secondary liability drivers 501 may include water quality, carbon emissions, social justice, wetland loss, anthropogenic altercations, or other liabilities that may occur. After the primary and secondary liabilities 500 and 501 are identified, the liabilities may be defined 503 and ranked according to importance and/or weighted with regard to a specific resource or case specific liability. Thus, the analyzer may determine a weighted list of liabilities impacted by the proposed plan.

Referring back to FIG. 3, parallel to or in series with the determinations made concerning the metric of liability 302 and the improvement of the baseline 303, the normalization of liability to restoration 304 determination may be performed. The normalization 304 includes a determination as to whether the restoration and/or produced solution is at least economically viable, and is at least fungible to the damaged resource. If the solution is not economically viable or not at least fungible to the damaged resource, the solution is not a robust solution, and the project will not offset the damage to the resource.

Along with the metric of liability 302, improvement of the baseline 303, and the normalization of the liability to restoration 304, a financial model 305 is generated. Referring to FIG. 6, a flowchart of a financial model according to an embodiment of the present disclosure is shown. In this embodiment, the liability is defined in terms of the demand for resources 600, and the project is defined in terms of the supply of a replacement product 601. The demand 600 and the supply 601 are input into the analyzer, and the analyzer performs a monetization of the cost of the supply in units supported by the demand 602. As such, the analyzer may determine the necessary supply needed to satisfy the demand, and may thus determine the required supply of products 603. The supply of products, or the products produced by the solution may then be analyzed to determine costs associated with the production of the products. For example, costs 604 may include costs for construction, operation, market place, regulatory acceptance, communication, certainty, sales risk, performance, capital administration, and other required costs to produce the supply. Such costs may be output by the analyzer for consideration prior to production.

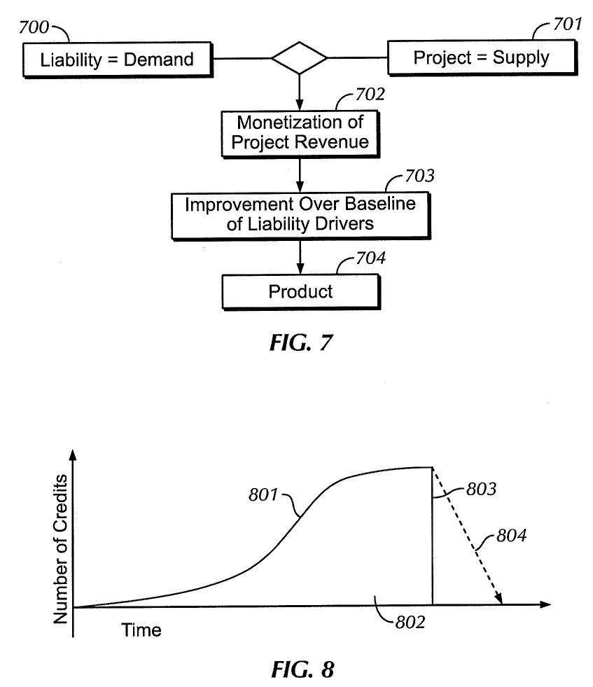

Referring to FIG. 7, a flowchart of a financial model for revenue according to an embodiment of the present disclosure is shown. In this embodiment, the liability is defined in terms of a liability being equal to a demand 700 and a project being equal to a supply 701, as described above. The demand 700 and supply 701 are then monetized 702 by the analyzer to produce an estimated project revenue. The project revenue may include a calculation of all income associated with the project, including the value of the resources produced. Additionally, the value of the revenue may be defined in terms of an improvement over baseline liability drivers 703. Such a calculation may use the efficiency multiplier, as explained in detail above, to determine a value of a product (or solution).

Moreover, the product may be grouped into units, representative of alternatives to the product (or solution), such that the units may be monetized into a single product (e.g., a credit) 704 and sold accordingly. Those of ordinary skill in the art will appreciate that the value of revenue may be defined in terms of an individual product, or in terms of a unit representing a plurality of products. For example, with respect to the groundwater example from above, a unit may be defined as including a volume of water equivalent to the amount of water produced by a passive recharge area. Thus, the product or the unit may be valued in terms of an alternative to the product or solution.

Referring back to FIG. 3, after the creation of the financial model 305, the analyzer determines whether the project is viable (as indicated by 306). The decision may include weighting the stated demand in view of the value of the credit, and then determining if the development of a solution and/or production of a product is economically viable. Other factors that may be considered are short-term versus long-term considerations, value of the credits and/or products generated, future marketability of the credits, and need for such a credit in the marketplace. If the analyzer determines that the project is economically viable, the project may then be approved 307. Going forward with the project may include the procurement of existing resources, the creation of resources using active recharge processes (e.g., collection of rainwater), or other methods of creating solutions and products as described herein. Those of ordinary skill in the art will appreciate that modifications to the above described procedures may occur without departing from the scope of the present disclosure. For example, in certain embodiments, the project analysis may include additional determinations to, for example, account for credit valuation differences over time.

The decision to proceed with a project may thereby allow for the elimination of environmental liability. For example, in one embodiment, environmental liability may be eliminated by determining an environmental liability based on an injury to an environment. A recharge operation, capable of producing a solution or product, as discussed above, may then be selected. After the operation is selected, the product of the operation may be quantified by translating the product of the operation into a monetized solution. The quantifying may further include determining an effect of the recharge operation and translating the effect into a second monetized solution. For example, in one embodiment, the defect of the recharge operation may be that as ground water is collected and treated, oils are removed from the water (as explained with respect to credit stacking). The effect (i.e., the removal of oil from the water), may then be translated into a second monetized solution, such as a second credit.

In another embodiment, the quantifying of the product may include determining a second product of the operation and translating the second product into a second monetized solution. In such an embodiment, the second product may thus be used in the creation of a second credit, thereby increasing the net value of the operation.

After the one or more products have been quantified, and translated into a monetized solution, the operation is implemented. The implementation of the operation may thereby result in the production of a product that is converted into a credit, which may be traded or purchased on the open market. Those of ordinary skill in the art will appreciate that the monetized solution may thus be transacted and used to offset an environmental liability.

In certain embodiments of the present disclosure, the solution and/or credits may be secured to increase a value of the credits upon transaction. Generally, after a damage caused by an environmental injury is determined and a solution to the damage is determined, the solution may be monetized into a credit that replaces the damage. The monetized credit may then be secured in the form of a financial instrument. Those of ordinary skill in the art will appreciate that exemplary financial instruments include surety bonds, trusts, finite risk policies, and guaranteed investment policies. Such financial instruments may thereby provide a guarantee that aspects of the solution and/or the value of the credit will be maintained over time.

Securing a credit with a financial instrument may include insuring a value of a credit for a period of time or insuring a value of a solution for a period of time. For example, in one embodiment in accordance with the above discussion, a solution may include the collection of water from hardscape. Securing the credit may include insuring the value of the credit by insuring that a certain volume of water will be generated in a certain period of time. Likewise, securing the credit may include insuring the solution, such that the infrastructure used to collect, process, and/or remediate the water is guaranteed. Examples of such insurance may include insuring implementation, operability, maintenance, and up-time of the infrastructure. In still other embodiments, insurance may secure the infrastructure from natural disasters, political insecurities, or other events that may disrupt the collection of a product produced by the solution, or otherwise damage the solution directly.

Those of ordinary skill in the art will appreciate that the value of credits used to replace environmental damage may find particular benefit in being secured. Solutions used to offset environmental liability may operate over periods of time, such that credits are accrued during the operation of the solution. Thus, the value of the credits and/or solutions may be directly impacted based on the ability of the credits and solutions to be secured. Referring to FIG. 8, a graph of credits generated by a solution over time, in accordance with embodiments of the present disclosure, is shown. In this embodiment, the y-axis of the graph represents the number of credits generated by a determined solution, while the x-axis represents time. As illustrated, a curve 801 representing the number of credits generated at a point in time increases the longer the project is operational. As such, an area under the curve, represented at 802, defines the net credits generated during the life of the solution.

Securing the credits generated by the operation thereby provides insurance that should an event occur that decreases the generation of credits, the value of the credits may be maintained. For example, if an event, such as a natural disaster (represented at 803), destroys or damages the solution, such that credit production decreases 804, the security interest maintains the value of the credits because the solution may be repaired. In terms of the water collection process described above, if an earthquake damaged collection and/or remediation operations of the solution, the security of the solution would fund repair of the operation. Said another way, securing the solution provides a guarantee for the net credits generated (i.e., the area under the graph 802).

Referring briefly to FIG. 10, a graph of stacked credits according to one embodiment of the present disclosure is shown. In certain embodiments, as described in detail above, a single solution may provide multiple benefits, thereby resulting in multiple credits being generated by the single solution. For example, in the water collection solution, the collected water may provide a recharge efficiency credit valued in terms of acres replace. However, the same solution may also remove contaminants (e.g., oil) from the water, thereby resulting in a stormwater mitigation credit valued in terms of pounds of contaminants removed. In certain situations, the same solution may further provide for investment in a community, thereby producing an environmental justice credit valued monetarily. Another type of credit that may be stacked includes a credit associated with a volumetric reduction in stormwater during periods of high rainfall, thereby decreasing the number of flood claims that would otherwise be paid out. Finally, FIG. 10 shows that a scarcity of supply credit may be stacked to account for the scarcity of a resource that may otherwise be destroyed or not provided for. The above list of stackable credits is exemplary in nature and those of ordinary skill in the art will appreciate that other types of credits may be stacked to further increase the value associated with a solution.

As FIG. 10 illustrates, each credit generated by a solution may be valued in its own terms. For example, a recharge efficiency credit may be valued in terms of acres of land replaced, while contaminant removal may be valued in terms of a mass of contaminant removed. Still other credits may be valued in economic terms, such as a net amount of dollars generated, donated, or saved, while in other embodiments, credits may be valued in specific terms, such as an amount of information provided or a quantity of species saved. Those of ordinary skill in the art will appreciate that each credit generated by a solution may thereby be measured scientifically/economically, or otherwise quantified in their own terms.

Additionally, stacking may include a solution providing multiple benefits in separate and discrete terms. Thus, assets from a single solution may be created separately, but valued together. Such valuation may then be monetized, such that the credits are additive in nature. For example, FIG. 10 provides a total ecological value as being the sum of five stacked credits (i.e., scarcity of supply, stormwater volume reduction, environmental justice, stormwater mitigation, and recharge efficiency). Thus, the ecological value of a particular solution may include valuing separate credits or outcomes together as a net ecological value. Alternatively, the value of independent credits, for example, recharge efficiency, could be valued independently, as described above. Those of ordinary skill in the art will appreciate that the slope and relative absolute values of ecological valuation curves (i.e., FIG. 10) may vary based on the specific solution used. As such, the graphical outcome of a measurement of ecological value may vary accordingly.

Furthermore, the security of the operation may innately increase the value of the credit. Because the credit is backed by a security interest, when credits are transacted based on the production of a solution, an organization purchasing the credits has financial assurance for the value of the credits. As such, those of ordinary skill in the art will appreciate that valuation of a credit may include determining a baseline calculation, recharge efficiency, scarcity, nexus, time, public good, contaminant removal, environmental benefit, and a security interest. The relative value of each of the above factors may thereby be used to calculate an initial value of a credit. Additionally, a security interest factor may insure that a solution achieves a specified contaminant removal, environmental benefit, recharge efficiency, etc.

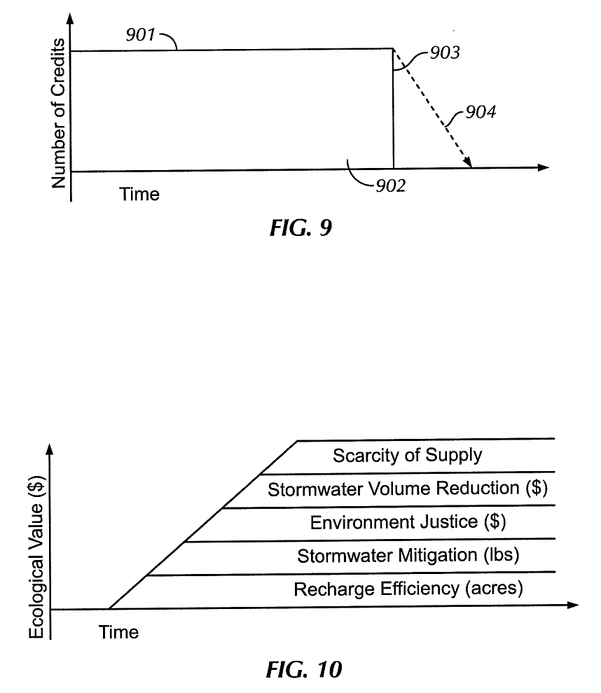

Referring to FIG. 9, another graph of credits generated by a solution over time, in accordance with embodiments of the present disclosure, is shown. In this embodiment, a credit generation solution may result in a credit production level 901 that is substantially stagnant over time. In such an embodiment, should an event occur (represented at 903) that causes the production of credits to drop-off or cease to exist 904, an area under the curve 902, representing the net volume of credits generated, may be insured. In such an embodiment including a solution having a substantially linear credit generation, securing the solution may allow for the creation, valuation, and transacting of credits. Because the number of credits collected over time is substantially constant, a value of credits may be pre-collected and transacted, thereby allowing for a credit representing a future service to be transacted before the credit is actually generated. The pre-selling of credits based on a future performance of the solution may thereby be sold to offset existing environmental liability. Those of ordinary skill in the art will appreciate that linear solutions may include solutions that have a constant credit generation over time, such as illustrated in FIG. 9, as well as credit generation that is linear with a positive or negative slope, thereby increasing or decreasing in a predictable manner with respect to time.

The guarantee of the credit based on the security interest in the solution may also allow for the credit to be valued at the time of sale on a future basis. Those of ordinary skill in the art will appreciate that the future value of the credit may include existing or expected credit valuation factors, such as, a baseline calculation, recharge efficiency, scarcity, nexus, time, public good, contaminant removal, environmental benefit, and security interest.

While embodiments including solutions that result in a substantially linear production of credits may be especially desirable to pre-sell, those of ordinary skill in the art will appreciate that because the area under the curve 902 (802 of FIG. 8) represents the net production of credits, non-linear credit production solutions may also gain benefit from pre-selling. For example, referring back to FIG. 8, in one embodiment, the credits produced 801 may become substantially linear as the solution matures, so as to allow for an accurate estimation of the number of credits produced. In other embodiments, the production of credits 801 may become relatively predictable, such that the number of credits generated for a period of time may be accurately estimated. In such embodiments, the estimated credits may then be pre-sold to offset environmental liability according to the same methods described above.

In any of the above methods including securing the value of the credits or solutions, the credits may be transacted. For example, in one embodiment, a credit may be created based on a monetized solution that offsets damage caused by an environmental injury. The value of the credit may then be guaranteed by a financial instrument. After the solution has produced a certain number of accrued credits over time, the credits may then be transacted in the open market. As such, a plurality of accrued credits may be transacted to offset a financial liability incurred as a result of an environmental liability, or may otherwise be used to directly remove an environmental liability.

In still other embodiments, a secured solution may no longer be required to offset an environmental liability. For example, the solution may have produced an agreed upon net quantity of credits, or the solution may no longer be required. In such a situation, the financial instrument used to secure the solution and/or credits may be transacted, such that the security interest is sold directly. Those of ordinary skill in the art will appreciate that credits, solutions, and financial instruments, as disclosed herein, may be transacted individually or in combination. As such, environmental or financial liability may be offset due to producing and transacting in the credits, solutions, and financial instruments securing the operation.

Referring briefly back to FIG. 1, in an embodiment including a financial assurance model, as described above, the credit may be secured after creation 106 and prior to exchange 107 or claim settlement 108. In other embodiments, the security of the credit may be used in the valuation 104 of the credit, as a parameter to increase the value. In still other embodiments, credit security may be used as a multiplier 105 to increase the value of the credit and/or the solution.

### EXAMPLE

In one aspect, the embodiments disclosed herein may be used in developing a restoration program that is commensurate with damages, which an agency, such as a state or federal agency, seek compensation. In this example, a method of establishing a credit-based approach to monetize a rainwater collection operation is analyzed. Methods according to the present disclosure, such as the following example, may include computer generated models and calculations used to determine the effectiveness of a particular operation at creating a monetized solution for a compensatory claim. The models may thereby be used to determine whether particular operations generate credits that meet the requirements of the claim. The methods disclosed herein may use computer modeling, computer networks, localized networks, etc. to gather, analyze, and determine the effectiveness of a particular solution to a claim.

The present example was generated to analyze solutions to satisfy an NRD claim for damage to groundwater sources. In establishing a model to determine the effectiveness of a solution, various quantity and quality factors were analyzed. The results of the solution were then analyzed in terms of water supply factors, stormwater mitigation factors, social factors, etc. The following factors may be used to analyze the benefit of creating usable water: recharge efficiency, scarcity of recharge, scarcity of supply, and distance to beneficial receptor. The recharge efficiency refers to an additional quantity of water on a per acre basis, which may be introduced into an aquifer through treated stormwater injection relative to the volume that may be attributed to natural recharge through open space protection. The scarcity of recharge refers to the benefit of providing recharge in more developed locations, where a higher proportion of impervious surfaces makes natural recharge less available. Scarcity of supply refers to the benefit of augmenting groundwater supplies in areas where clean groundwater is scarce due to water quality or availability issues. Distance to beneficial receptor refers to the added benefit of providing groundwater recharge in the immediate vicinity of a water supply well in comparison to the protection of natural recharge at a more distant location.

Additionally, the water supply benefits may be modeled. Water supply benefits may be modeled according to factors such as contaminant reduction, stream impairment mitigation, infrastructure damage mitigation, and distance to sensitive receptor/mitigation of stormwater injury. Contaminant reduction refers to benefits associated with stormwater treatment and injection of reducing the quantity of pollutants entrained in stormwater runoff. Thus, to determine contaminant reduction, the incremental benefit may be measured relative to the pollutant runoff that is avoided by protecting open space that might otherwise be developed. Stream impairment mitigation refers to the benefit of reducing stormwater runoff into streams that are relatively sensitive to flood-related impacts such as erosion. Infrastructure damage mitigation refers to the benefit of reducing stormwater runoff in areas that are relatively sensitive to flood-related impacts, such as road washout, culvert failure, and public and private structure inundation.

Social factors were also analyzed and modeled. Social factors may include public good and social benefits associated with providing a solution in a particular environment. Those of ordinary skill in the art will appreciate that the particular factors and benefits that are modeled may depend on the type of solution considered. Thus, the particular factors and benefits discussed in this example are not a limitation on the scope of the present disclosure.

To further clarify how particular solutions may be modeled, the above described exemplary factors and benefits will be described in detail below. The recharge efficiency factor equals the product of a base recharge efficiency factor and an adjustment factor, which captures the value that an open space acre provides a recharge benefit when it prevents development and the development that would otherwise have occurred fails to ensure no net loss of recharge. The base recharge efficiency factor is calculated according to the following equation:

Stormwater injection volume per unit acre=P·Eᵢ Equation (1)

where P is the annual precipitation, determined in millions of gallons per acre per year, and Eᵢ is the injection efficiency (i.e., the percentage of he total precipitation volume that is injected). The injection efficiency sub-factor accounts for a solution not treating 100% of the total annual precipitation due to collection, treatment, and injection inefficiencies and/or limitations.

A base recharge efficiency factor for a specific site is then calculated by dividing the net annual stormwater injection volume by the average natural recharge volume. After the base recharge efficiency factor is determined, the factor requires adjustment to account for specifics of a particular site and/or solution. One method of adjusting the base recharge efficiency includes the calculation of adjusted benefits according to the following equation:

$$Adjusted benefits = {\sum }_{y = 0}^{N - 1} {\sum }_{t = 0}^{N - 1 - y} [ N - t - y ] {p}_{t}^{F} {p}_{y}^{D} \qquad Equation ( 2 )$$

where N is the total number of years to be assessed, y is the index denoting year number, t is the index denoting the number of years after development, p^{F}ₜ is the probability of recharge maintenance failure during year t after development, and p^{D}_{y} is the probability of development during year y. Thus, the adjusted benefits equation may be used to determine the amount of benefit that would accrue to a protected open space acre if it were developed in a particular year, taking into account the probability of recharge maintenance failure each year. Finally, the base recharge efficiency factor is multiplied by the adjustment factor to determine the overall recharge efficiency factor.

Additionally, the scarcity of recharge factor may be determined and modeled. To determine the scarcity of recharge for a particular solution at a given site, a relationship of the degree of development in the vicinity of a project location relative to the degree of development in the broader region within which open space protection may occur as an alternative means to replace ground water is determined. Using a geographic information system (“GIS”), the total acres of a site and corresponding watershed region, as well as the total areas within each that are classified as impervious surface, open water, or wetlands, is determined. The scarcity of recharge factor is thus the ratio of the percent non-recharge area” at a site to the watershed region.

The contaminant reduction factor may also be determined and modeled. One method of modeling the contaminant reduction factor includes using a total suspended solids value as a proxy contaminant, assuming that the solution will eliminate all offsite runoff of the solids, assume that the development that would otherwise occur in an open space is the same as at the project site, and assume that in absence of development the solids runoff from an open space would be zero. This ratio is then modified according to local regulations that define the reduction of solid loads, such as an 80% reduction, at certain locations. Thus, for a location requiring an 80% reduction in solids loads, the credit factor ratio for contaminant reduction is:

(Prevented contaminant runoff_{project})/(0.2·Avoided contaminant runoff_{open space}) Equation (3)

Thus, for the present solution, according to local regulations, the credit factor will equal 5. Those of ordinary skill in the art will appreciate that in other project solutions, the credit factor may vary according to the amount of information specific to the site that may be collected. For example, in certain aspects, the model may be modified by determining a volume of contaminant actually removed. Thus, the model may be supplemented with actual known data, when available.

Additionally, a discounted recharge efficiency may be calculated and modeled. An example of a discounted recharge efficiency may result as temporal limits to the benefits of a solution for a particular location are exhausted. Because open space, as opposed to a particular solution, may provide benefits for a particular period, as opposed to perpetuity, the temporal factor may resulted in a discounted recharge efficiency. To determine the disclosed recharge efficiency, the effective recharge acres calculated by the preceding factors in the present solution are discounted by 65%. Thus, for a particular time period of use of a solution, the benefits are reduced. Those of ordinary skill in the art will appreciate that the particular type of solution, and the type of site in which the solution is used may result in different discounted efficiency calculations, and the discount rate of 65%, of the present example, is only an illustration of one possible discount.

To determine the discounted multiple factor weighted average, a system of weighting each of the above discussed factors may be used. In the present example, each of the factors was assigned a relative value based on the benefit of each category. For example, the recharge efficiency may be assigned a value of five, which the contaminant reduction is assigned a value of two, and the recharge scarcity is assigned a value of one. Such relative weighting methods may thereby ensure that an estimated credit calculated understates the benefits of a particular solution, and thereby results in an overcompensation to the public relative to the original injury. Those of ordinary skill in the art will appreciate that the type of solution may result in different weighted averages, and as such, the values assigned to each factor in the present example are an illustration of the type of weighted averages that may be applied.

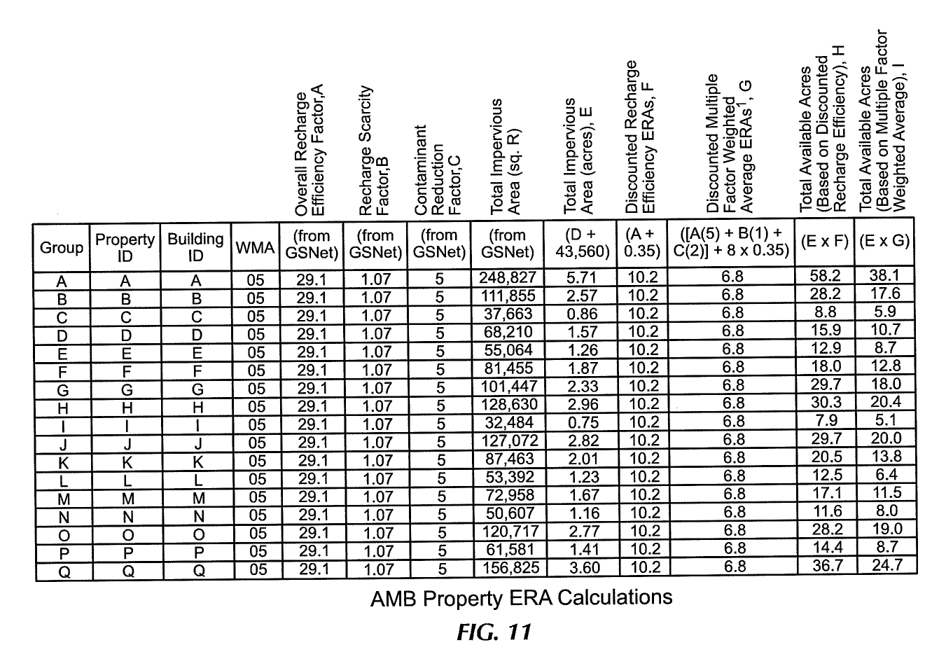

After determining a discounted multiple factor weighted average, the total area that may be used may be multiplied with the discounted multiple factor weighted average to determine a total available acres. Additionally, a total available acreage, based on the discounted recharge efficiency may be calculated by multiplying the total impervious area by the discounted recharge efficiency. Examples of such calculations for the particular example are summarized in FIG. 11.

Thus, in certain embodiments, a computer model may be outputted as a visual representation on a computer. The model may be displayed as a graphical representation of numerical data, such as in tabular form, or in other embodiments, may be displayed as a graphical representation. Additionally, read and writable media may be used to save software instructions for processing and/or generating the models. Examples of read and writable media may include CDs, DVDs, or other memory components that may be a part of or used with a computer system.

In analyzing the data displayed in FIG. 1, a computer or human may quantitatively interpret the data, to determine if a proposed solution provides a desired benefit. In addition to interpreting the qualitative data in FIG. 11, the computer or human may qualitatively interpret additional factors, to decide if the solution provides benefits beyond the qualitative interpretation. Examples of qualitative factors that may be interpreted include stream impairment, infrastructure damage, sensitive receptor benefits, travel time benefits, water supply, and/or public good factors. Analyzing the above factors may occur as described above, and when a computer model is generated, additional data, such as GIS data, may be analyzed to determine other potential benefits of a solution.

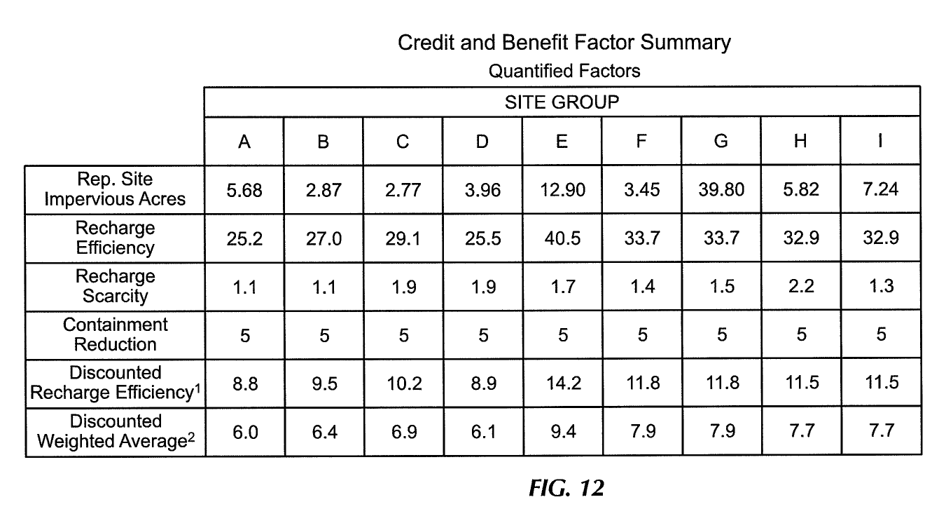

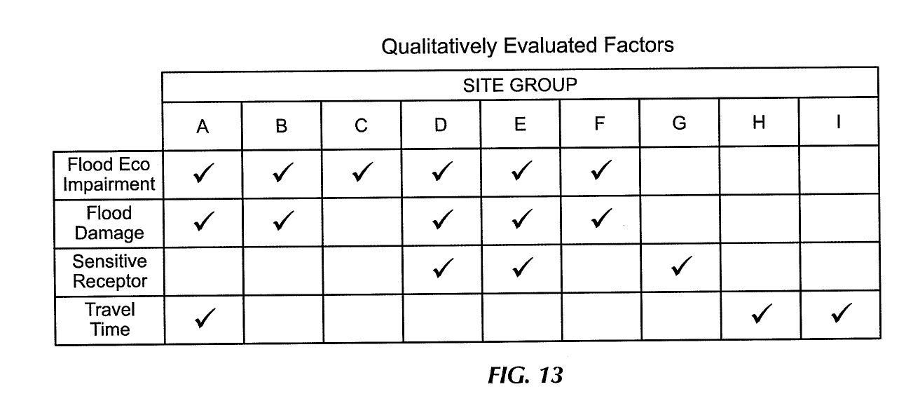

Computer generated models may thereby provide for a solution that creates an optimal benefit for a specific solution. Referring briefly to FIGS. 12 and 13, computer generated data representing quantitative and qualitative factors, respectively, according to embodiments of the present disclosure, are shown. As discussed with respect to the example, quantified factors for site groups A through I may be calculated to determine whether a particular solution provides the requisite value for the creation of a financial product, such as a credit (FIG. 12). Similarly, qualitative factors for site groups A through I may be evaluated to see if any additional benefits may be realized (FIG. 13).

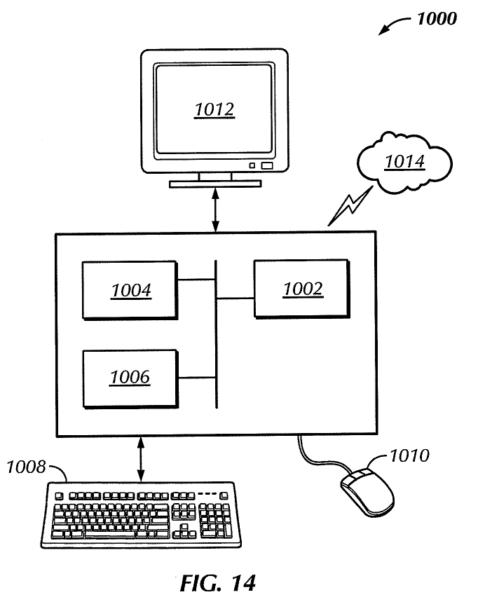

Embodiments of the present disclosure may be implemented on virtually any type of computer regardless of the platform being used. For example, as shown in FIG. 14, a computer system 1000 includes one or more processor(s) 1002, associated memory 1004 (e.g., random access memory (RAM), cache memory, flash memory, etc.), a storage device 1006 (e.g., a hard disk, an optical drive such as a compact disk drive or digital video disk (DVD) drive, a flash memory stick, etc.), and numerous other elements and functionalities typical of today's computers (not shown). The computer 1000 may also include input means, such as a keyboard 1008, a mouse 1010, or a microphone (not shown).

Further, the computer 1000 may include output means, such as a monitor 1012 (e.g., a liquid crystal display (LCD), a plasma display, or cathode ray tube (CRT) monitor). The computer system 1000 may be connected to a network 1014 (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system 1000 includes at least the minimal processing, input, and/or output means necessary to practice embodiments of the invention.

Further, those skilled in the art will appreciate that one or more elements of the aforementioned computer system 1000 may be located at a remote location and connected to the other elements over a network. Further, embodiments of the invention may be implemented on a distributed system having a plurality of nodes, where each portion of the invention (e.g., data repository, signature generator, signature analyzer, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Advantageously, embodiments of the present disclosure may allow for the creation of credits usable in offsetting environmental liability. Security of the credits by financial instruments may increase the likelihood that a solution is enacted, such that credits are created. Additionally, guaranteeing the credits may be used in the valuation and transacting of the credits to insure the value of the credit or the solution over a period of time. In certain embodiments, the security of the solution may also allow credit transactions to include the pre-selling of credits based on future performance models of the solution, thereby increasing the value of the credits and/or the solution.

Creation of the credits may also allow for the provision of replacement resources, thereby allowing natural resource damage claims to be settled efficiently. Because the credits may be valued in terms of the damage or alternative solutions, the credits may be purchased, held, or sold. Thus, the credits may be readily available, such that the processes of compensating a trustee for an environmental injury may be more efficient.

Also advantageously, embodiments of the present disclosure may promote the production of solutions and products in the private sector that may be purchased by responsible parties to offset the environmental liability. Because solutions, such as rainwater collected on buildings, belong to private citizens, not the state, the private citizens may be more active in promoting the solutions, thereby further increasing the pool of credits available to responsible parties. As the pool of credits increases, the efficiency of compensation may be further increased.

Additionally, embodiments of the present disclosure may provide a scientifically determinable method for valuing the created credits. Because the method of valuation is based on the value of the resource, rather than the value of the land, the credit is more closely related to the injury model. Specifically, the purpose of the resource compensation is to make whole a trustee of land for the damage incurred to the land by a responsible party. Methods of valuation disclosed herein allow for the compensation to be commensurate to the injury, thereby promoting the integrity of the compensation schema.

Advantageously, embodiments disclosed herein may promote the creation of additional resources not previously available. Because the traditional compensation scheme required the purchase of land, and because the land would be recharging naturally anyway, the compensation maintained status quo resources. Embodiments disclosed herein provide an additional resource, such as actively collected water that would otherwise go uncollected, and thus unused. The creation of this additional resource may thereby promote resource conservation and environmental sustainability.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims. In particular, although select embodiments discuss injury/pollution/damage to groundwater, one of ordinary skill in the art will appreciate that methods disclosed herein pertain to any environmental damage.

What is claimed:

1. A method of creating environmental credits, the method comprising:
determining a damage caused by an environmental injury;
determining a solution for the damage;
monetizing the solution into a credit that replaces the damage, wherein the credit is valued in terms of the environmental injury; and
creating the credit.

2. The method of claim 1, further comprising:
exchanging the credit to replace a liability.

3. The method of claim 2, further comprising:
settling a claim based on the exchanging of the credit.

4. The method of claim 1, wherein the credit comprises at least one of an ecological credit, a cultural credit, and a social credit.

5. The method of claim 1, further comprising:
valuing the credit, wherein the valuing comprises:
determining a value of the credit based on at least one of a baseline calculation, recharge efficiency, scarcity, nexus, time, public good, contaminant removal, environmental benefit, and combinations thereof.

6. The method of claim 5, wherein the valuing further comprises:
determining a value of a credit based at least in part on a value of a stacked credit.

7. The method of claim 1, further comprising:
monetizing the solution into a second credit that replaces a second damage, wherein the credit is valued in terms of the environmental injury; and
creating the second credit.

8. The method of claim 1, further comprising:
comparing the valued solution to a passive recharge area.

9. The method of claim 1, further comprising:
implementing a recharge operation to produce the solution.

10. The method of claim 9, wherein the recharge operation comprises collecting water.

11. The method of claim 1, further comprising:
securing the credit with a financial instrument.

12. The method of claim 11, wherein the securing comprises:
insuring a value of the credit for a period of time.

13. The method of claim 11, wherein the securing comprises:
insuring the solution for a period of time.

14. A method of valuing environmental credits, the method comprising:
determining a solution to an environmental damage;
monetizing the solution into a credit;
valuing the credit based on the environmental benefits of the solution; and
outputting the valuation.

15. The method of claim 14, wherein the valuing comprises:
quantifying the credit based on an environmental benefit.

16. The method of claim 15, wherein the quantifying comprises:
defining an efficiency multiplier; and
determining the value of the credit based on the efficiency multipier.

17. The method of claim 16, wherein the efficiency multiplier comprises at least one of a scarcity factor, a nexus factor, a time factor, a baseline factor, a public good factor, a contaminant removal factor, environmental benefit, and combinations thereof.

18. The method of claim 14, wherein the value of the credit is based at least in part on a stacked credit.

19. A method of satisfying environmental liability, the method comprising:
determining an environmental liability, wherein the environmental liability is based on injury to an environment;
selecting a recharge operation, wherein the recharge operation produces a product;
quantifying the product of the recharge operation, wherein the quantifying comprises: translating the product of the recharge operation into a monetized solution; and
implementing the recharge operation.

20. The method of claim 19, further comprising:
valuing the product of the recharge operation in terms of an environmental benefit.

21. The method of claim 19, further comprising:
transacting the monetized solution to offset an environmental liability.

22. The method of claim 21, wherein the monetized solution comprises at least one of an ecological credit, a cultural credit, and a social credit.

23. The method of claim 19, wherein the quantifying further comprises:
determining an effect of the recharge operation; and
translating the effect into a second monetized solution.

24. The method of claim 19, wherein the quantifying further comprises:
determining a second product of the recharge operation; and
translating the second product into a second monetized solution.
